(19) United States
(12) Patent Application Publication
(10) Pub. No.: US 2012/0023824 A1
(43) Pub. Date: Feb. 2, 2012

(54) AUTOMATIC DOOR OPENER

(75) Inventor: Grant Matthew Mason, Charlotte, NC (US)

(73) Assignee: RUBBERMAID COMMERCIAL PRODUCTS, LLC, Winchester, VA (US)

(21) Appl. No.: 13/192,912

(22) Filed: Jul. 28, 2011

Related U.S. Application Data
(60) Provisional application No. 61/368,910, filed on Jul. 29, 2010.

(51) Int. Cl. E05F 15/00; E05F 15/02

(52) U.S. Cl. 49/29; 49/340

(57) ABSTRACT

A door opener for opening a door having an external surface comprises a screw mounted for rotary motion and a carriage mounted on the screw such that rotation of the screw causes motion of the carriage along the screw. A motor rotates the screw. An actuator arm has a first end and a second end, where the actuator arm is operatively connected to the carriage such that movement of the carriage causes the actuator arm to move between a retracted position where the door is closed and an extended position where the door is open. The first end of the actuator arm is in contact with but not connected to the external surface of the door such that the first end of the actuator arm rides over the external surface of the door.

This application claims benefit of priority under 35 U.S.C. §119(e) to the filing date of to U.S. Provisional Application No. 61/368,910, as filed on Jul. 29, 2010, which is incorporated herein by reference in its entirety.

### BACKGROUND

The invention relates to automatic door openers such as may be used to open doors in public settings. Such door openers typically comprise a motorized mechanism that moves the door between an open and closed position upon actuation by a user.

### SUMMARY OF THE INVENTION

A door opener for opening a door having an external surface comprises a screw mounted for rotary motion and a carriage mounted on the screw such that rotation of the screw causes motion of the carriage along the screw. A motor rotates the screw. An actuator arm has a first end and a second end, where the actuator arm is operatively connected to the carriage such that movement of the carriage causes the actuator arm to move between a retracted position where the door is closed and an extended position where the door is open. The first end of the actuator arm is in contact with but not connected to the external surface of the door such that the first end of the actuator arm rides over the external surface of the door.

The door opener may further comprise a bearing on the carriage that resists rotation of the carriage about the axis of screw when the screw is rotated. The bearing may comprise a roller bearing received in a slot. The carriage may be connected to a first end of a linkage at a first pivot where the opposite end of the linkage is pivotably connected to the actuator arm at a second pivot. The second pivot may be positioned at the first end of the actuator arm. The first end of the actuator arm may comprise a bearing surface that contacts the external surface of the door. The bearing surface may comprise a roller that contacts the external surface of the door. The motor may be actuated in response to a signal from a sensor. A controller may control activation of the motor in response to the signal. The controller may activate the motor for a predetermined period of time. The sensor may be a touchless pad. A limit switch may control the movement of the carriage. The first end of the actuator arm may comprise a bearing surface that contacts the external surface of the door where the exterior surface may comprise a wear plate attached to the door. A door closer mechanism may move the door when the actuator arm is moved from the extended position to the retracted position to return the door to the closed position.

### BRIEF DESCRIPTION OF THE DRAWINGS

FIG. 1 is a back perspective view of one embodiment of the door opener of the invention in the closed position.

FIG. 2 is a back perspective view of the embodiment of the door opener of FIG. 1 in a partially open position.

FIG. 3 is a back perspective view of the embodiment of the door opener of FIG. 1 in a fully open position.

FIG. 4 is a front perspective view of the embodiment of the door opener of FIG. 1 in the closed position.

FIG. 5 is a top view of the embodiment of the door opener of FIGS. 1 and 2 in the open position.

FIG. 6 is a perspective view of the embodiment of the door opener system of FIG. 1.

FIG. 7 is a top view of another embodiment of the door opener of the invention.

FIG. 8 is a top view of yet another embodiment of the door opener of the invention.

FIG. 9 is a perspective view of still another embodiment of the door opener of the invention.

FIG. 10 is a top view of yet another embodiment of the door opener of the invention.

### DETAILED DESCRIPTION OF EMBODIMENTS OF THE INVENTION

The invention relates to the touch-free opening of a door such as a restroom door. The automatic door opener described herein may be used with standard size interior doors, although it has utility with any door. In the door opener of the invention an actuator arm contacts and moves over the surface of the door, but is not attached to the door, such that the door may be opened manually if desired. As a result, the door opener provides automatic and manual operation of the door and, in the event of a power failure or other failure in the unit, the door remains operational. The automatic door opener provides an affordable solution for a touch-free exit/entrance and has particular use in away-from-home applications such as restrooms. Touch-free operation in such environments eliminates potential points for cross-contamination between users.

The automatic door opener may comprise an actuator arm that pushes open the door. In one embodiment the actuator arm is connected to a linkage that is in turn connected to a carriage that runs along a drive screw. In one “pull-type” embodiment, one end of the actuator arm is pulled in a first direction to move the opposite end of the arm in a second direction to an extended position to open the door. In one “push-type” embodiment the actuator arm is pushed to the extended position to open the door. The drive screw may be rotated by a geared motor. The free end of the actuator arm is not connected to the door. A bearing or roller, mounted at the free end of the arm, rides along an exterior surface of the door such that the door can be opened manually or automatically.

The drive mechanism uses a sliding linear bearing or a roller bearing and slot arrangement to prevent the carriage from rotating about the screw and to control the linear motion of the carriage along the axis of the screw. The bearing also resists the twisting forces generated by the applied loads on the drive from the door.

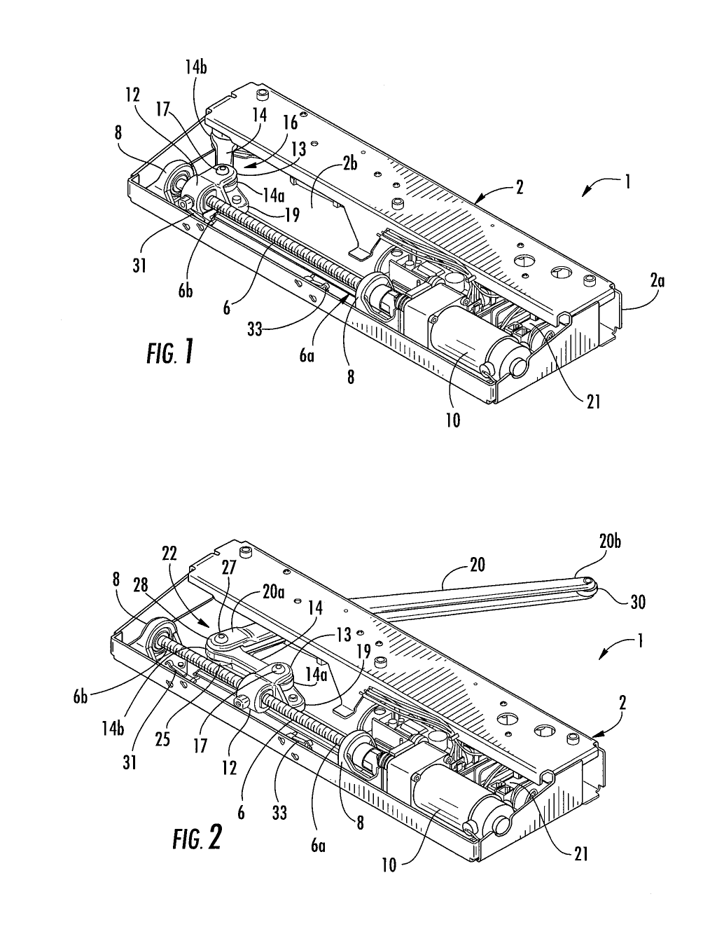

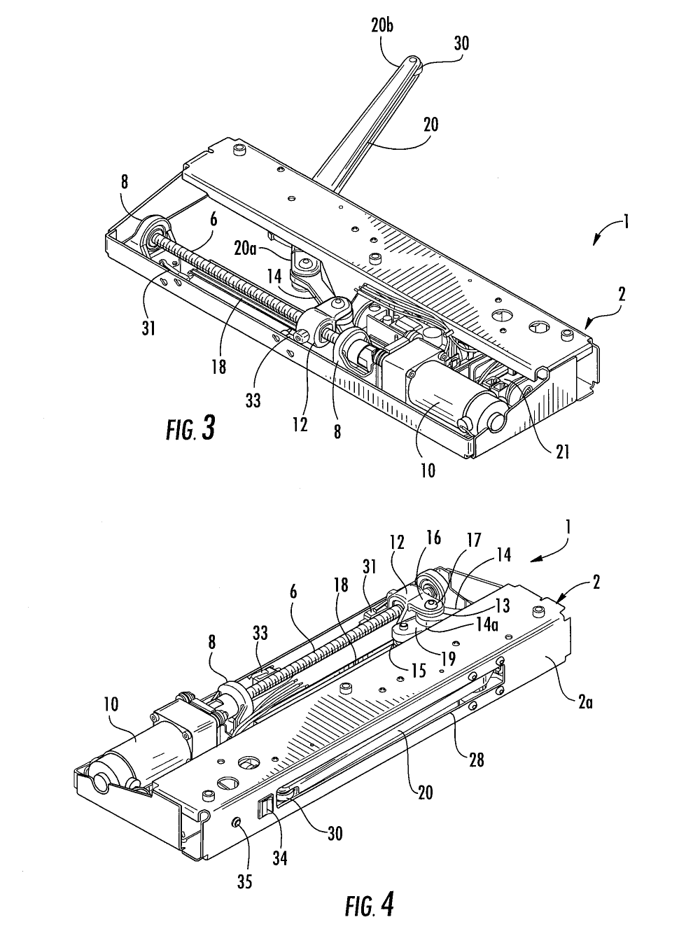

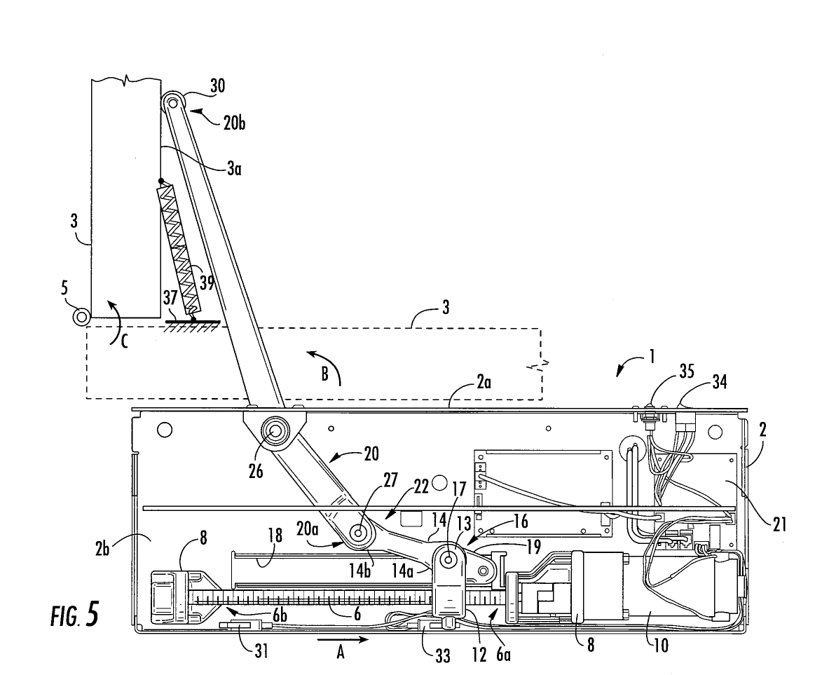

FIGS. 1 through 5 show a first embodiment of the automatic door opener of the invention. This embodiment is a “pull-type” design where the first end of the actuator arm is pulled by the drive mechanism in a first direction to move the opposite end of the actuator arm in the opposite direction to the extended position. The pull-type design minimizes size requirements of the unit and is able to handle the load requirements to open a door.

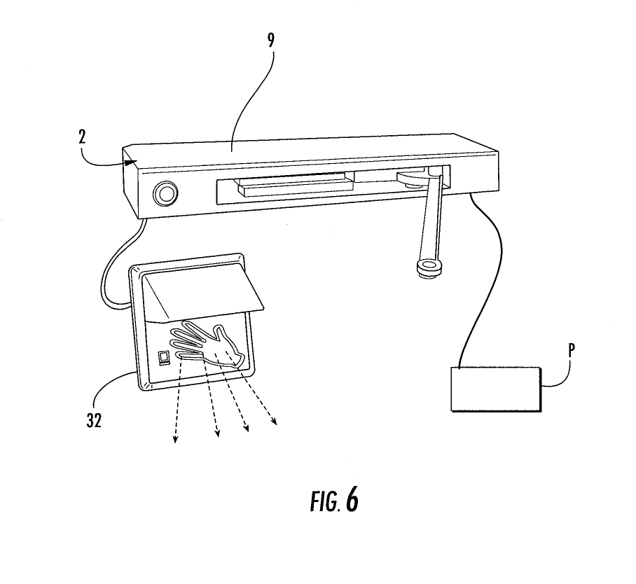

The opener 1 comprises a housing 2 mounted adjacent to a door such that the front of the housing 2a and actuating arm 20 faces the door. In the illustrated embodiment the device is shown with housing covers removed to reveal the internal drive mechanism of the opener. In actual use the mechanism may be covered by a removable cover 9 as shown in FIG. 6 to isolate the drive mechanism from the external environment and to provide a more pleasing aesthetic appearance. As shown in FIG. 5, the door 3 and opener 1 are arranged such that the door swings away from the front 2a of housing 2 between the closed, dashed-line position and the open solid-line position. The housing 2 may be mounted to the top of a door jamb, a ceiling or other structure adjacent the face of the door.

The housing 2 supports a drive screw 6 comprising threads that is supported at each end in bearings 8 such that the screw 6 may rotate about its longitudinal axis. The screw 6 extends along the back of the housing 2 and is rotated by a reversible geared motor 10.

A carriage 12 is mounted on the screw 6 and engages the screw threads such that rotation of the screw 6 causes the carriage 12 to move along the length of the screw 6. The screw 6 is rotated in a first direction to move the carriage 12 toward one end 6a of the screw and is rotated in the opposite direction to move the carriage 12 toward the opposite end 6b of the screw 6. The carriage 12 includes a roller or bearing 15 that is received in a slot 18 formed in the bottom wall 2b of housing 2 such that that it resists rotation of the carriage 12 about the axis of screw 6 when the screw is rotated and maintains the orientation of the carriage 12 relative to the screw thread 6 as the carriage 12 traverses the length of the screw 6. The bearing 15 also resists the twisting forces applied to the drive mechanism caused by the applied loads from the door.

The carriage 12 is connected to a first end 14a of linkage 14 at a pivot 16 such that the linkage 14 can rotate relative to the carriage 12. In one embodiment the carriage 12 is formed with an upper flange 13 spaced from a lower flange 19 a distance sufficient to receive the first end 14a of linkage 14 therebetween. A pivot pin 17 extends between and is supported by the flanges 13 and 15 and extends through a through hole formed in the first end 14a of linkage 14 such that the linkage 14 may freely pivot relative to the carriage 12. The roller or bearing 15 may be supported on the bottom side of the flange 19.

The opposite end 14b of the linkage 14 is pivotably connected to a first end 20a of the actuating arm 20 at pivot 22 such that the arm 20 can rotate relative to the link 14. In one embodiment the arm 20 is formed with an upper flange 23 spaced from a lower flange 25 a distance sufficient to receive the second end 14b of linkage 14 therebetween. A pivot pin 27 extends between and is supported by the flanges 23 and 25 and extends through a through hole formed in the second end 14b of linkage 14 such that the linkage may freely pivot relative to the actuator arm 20. The arm 20 is pivotably connected to the housing 2 at a pin 26 that is located between the ends 20a and 20b of arm 20. The opposite free end 20b of the arm 20 extends through a slot 28 formed in the front 2a of housing 2 such that the arm 20 can be extended from the housing through slot 28 upon actuation of the motor 10. The end 20b of arm 20 comprises a roller, low friction surface, ball bearings or other similar bearing surface 30 that contacts an exterior surface 3a of the door 3 to push on and slide across the exterior surface of the door and swing the door open about door hinges 5. The exterior surface 3a may be the surface of the door, a metal plate attached to the door to provide a wear surface or other surface attached to the door. A standard return spring 39 may be provided on the door 3 to return the door to the closed position upon retraction of arm 20 and to maintain the door in contact with the surface 3a during extension and retraction of arm 20.

The motor 10 and controller 21 are connected to a source of electrical power P and to a sensor such as a touchless pad 32 (FIG. 6). Touchless pad 32 comprises an emitter/receiver that detects reflected light when a user places his or her hands in the light path. The emitter/receiver is disposed such that the light is projected downwardly along the wall rather than perpendicular to the wall. In one embodiment the light is projected at about a 15 degree angle to vertical such that the light is approximately projected 2-6 inches from the wall or other surface on which the sensor 32 is mounted. By projecting the light vertically in close proximity to the wall the sensor is not inadvertently activated by a person walking past the sensor. Rather, the user must place a hand adjacent to the wall to activate the sensor. The power source P may be a battery, a hard wire connection to a buildings power grid, a plug and socket connection or the like. When a user activates the touchless pad 32, such as by moving their hand close to the pad, the sensor activates motor 10 to open the door as will be described. The sensor 32 transmits a signal to controller 21 and controller 21 transmits a signal to motor 10 that activates the motor. The controller 21 may be a control board, PLC controller, microprocessor or the like. The signal may be transmitted from the sensor to the controller by a hard wire connection (as shown), radio signal, or other wireless signal or the like. While a wall mounted touchless pad 32 is shown, the system may be activated using any suitable sensor such as a floor mat, infra red detector or the like but a sensor that does not require that the user to touch the device by hand is preferred. A manually operated switch 34 may be provided to deactivate the system. Indicator lights 35 may also be provided to indicate faults and or operation of the automatic door opener. The range of motion of the arm between the fully opened position and fully closed position may be controlled by using a stepper motor, limit switches 31, 33 or the like.

In operation a user activates sensor 32 by moving their hand close to, but not touching, the touchless pad. Upon sensing the user, the sensor 32 transmits a signal to controller 21. The controller determines if the door is closed by limit switches 31, 33. If limit switch 31 is closed the arm is in the retracted position and the door is in the closed position. Controller 21 transmits a signal to activate motor 10 to initiate operation of the door opener. Motor 10 rotates screw 6 to move carriage 12 along the length of screw 6 toward the end 6a of screw 6 in the direction of arrow A (FIG. 5). As the carriage 12 moves along screw 6 it moves the first end 14a of linkage 14 in the same direction A. Linkage 14 is free to rotate relative to carriage 12 to accommodate the arc of travel of the end 20a of arm 20 as arm 20 rotates about pivot 26. As the linkage 14 moves in the direction of arrow A, the first end 20a of arm 20 is “pulled” causing the arm 20 to rotate about pin 26 in the direction of Arrow B such that the distal free end 20b of arm 20 is rotated away from housing 2. The bearing surface 30 contacts the external surface 3a of door 3 and pushes against and rides along surface 3a as the arm 20 is extended to move the door to the open position. The force generated by motor 10, linkage 14 and arm 20 is great enough to overcome the spring force of spring 39 and the weight of the door and move the door to the open position. In one embodiment the peak torque to initially set a 100 lb, 34 inch door in motion is 398 lbf.in (45 Nm) and for a 200 lb, 48 inch door is 850 lbf.in (96 Nm). Arm 20 rotates door 3 about hinges 5 in the direction of arrow C to open the door. When carriage 12 reaches the end of travel it contacts limit switch 33. Limit switch 33 transmits a signal to controller 21 to stop motor 10 and halt the movement of arm 20 and door 3. Alternatively, a stepper motor may be used where a controller counts rotation of the screw 6 or of the output shaft of motor 10 and stops rotation of the motor when the count reaches a predetermined value corresponding to the end of motion of the carriage. Other mechanisms for detecting or determining the end of travel of the carriage or arm may also be used.

The arm 20 remains in the extended position to hold the door 3 in the open position for a predetermined period of time as set in controller 21 allowing the person to pass through the doorway. Upon expiration of the predetermined period of time the controller transmits a signal to actuate the motor 10. Motor 10 is reversed causing the carriage 12 and linkage 14 to move toward end 6b of screw 6 (opposite arrow A). Movement of linkage 14 causes arm 20 to retract back toward housing 2 (opposite arrow B) allowing the door to move to the closed position (opposite arrow C). When carriage 12 reaches the end of travel it contacts limit switch 31. Limit switch 31 transmits a signal to controller 21 to stop motor 10 and halt the movement of arm 20. The motor is stopped by limit switch 31 when the carriage reaches end 6b of screw 6 and arm 20 is in the fully retracted position. In one embodiment the door comprises a separate door closer mechanism 39 connected between door 3 and the door frame 37 or other structure that operates to move the door 3 to the closed position upon retraction of arm 20. The door closer mechanism 39 may comprise a hydraulically dampened spring or other similar device. The separate door closer mechanism 39 resists the opening of the door and pulls the door 3 against the bearing surface 30 as the arm 20 is extended during opening of the door to maintain contact between the exterior surface 3a of door 3 and bearing surface 30. The resistance force provided by door closer mechanism 39 provides for controlled opening of the door such that the arm 20 does not swing the door open in an uncontrolled manner. When the arm 20 is retracted allowing the door to close the door will close at the speed allowed by the door closer mechanism 39. For example the arm 20 may be retracted relatively quickly such that the arm is retracted in 4 seconds while the door closer mechanism may limit closing of the door to a slower speed such that the door closes in 5 seconds.

To open the door, a person may either activate the sensor for automatic operation or the user may simply push the door to open the door manually. Because the door is not connected to the door opener manual operation of the door is unaffected by the door opener.

The controller 21 may also be used to provide a safety feature to prevent the automatic opening of a blocked door. The controller detects the amount of current drawn by the motor to move the door to the open position. If the amount of current exceeds a predetermined maximum amount of current needed to open a freely movable door, the motor is reversed to prevent the continued opening of the door against an unanticipated load.

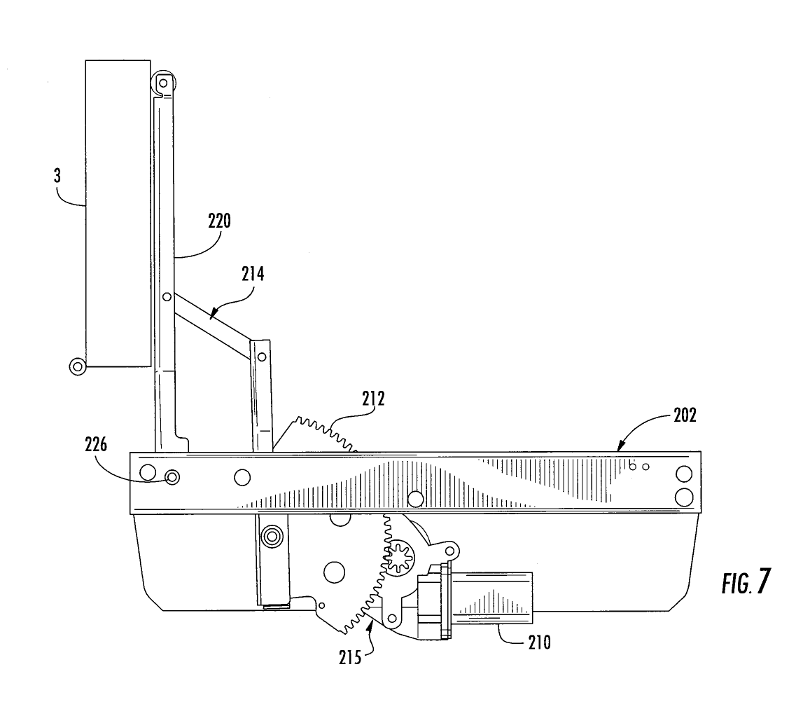

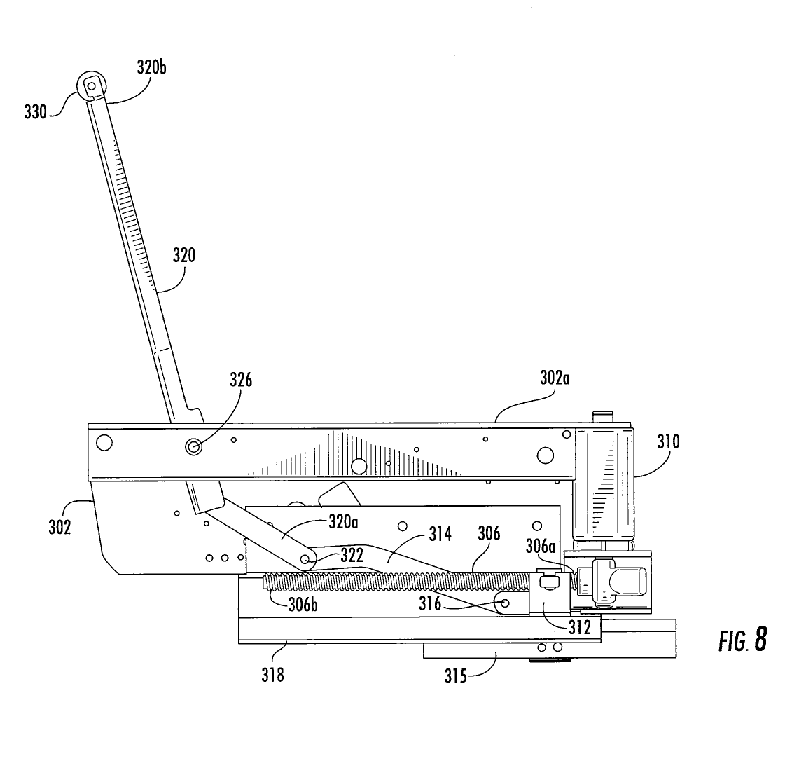

FIG. 7 shows another embodiment of the automatic door opener. The opener has a housing 202 mounted adjacent a door such that the front of the housing and actuating arm 220 face the door. The door is arranged such that it swings away from the front of housing 202 as previously described. The housing 202 may be mounted to the top of a door jamb, a ceiling or other structure. Motor 210 drives a sector gear 212 via a transmission such as a gear reducer 215. The sector gear 212 is connected to actuator arm 220 via linkage 214. Arm 220 is connected to housing 202 at pivot 226. Actuation of motor 210 rotates gear 212 to move linkage 214 to rotate arm 220 to the extended position about pivot 226. Reversing motor 210 rotates actuator arm 220 to the retracted position where door 3 is closed. Alternatively, the actuator arm 220 may be connected directly to the gear 212 without an intermediate linkage 214. The opener of FIG. 7 may be used with the sensor, controller, power source, return spring and limit switches/stepper motor as described above to control the motion of arm 220.

FIG. 8 shows another “pull-type” drive mechanism showing the opener with the actuator arm 320 in the fully extended open position. The opener has a housing 302 mounted adjacent a door such that the front of the housing 302a and actuating arm 320 face the door. The door is arranged such that it swings away from the front 302a of housing 302 as previously described. The housing 302 may be mounted to the top of a door jamb, a ceiling or other structure. A screw 306 comprising threads is mounted for rotation in housing 302. The screw 306 is rotated by a geared motor 310. A carriage 312 is mounted on the screw 306 such that rotation of the screw 306 causes the carriage 312 to move along the length of the screw. The screw 306 is rotated in a first direction to move the carriage toward one end 306a of the screw and is rotated in the opposite direction to move the carriage toward the opposite end 306b of the screw 306. The carriage 312 is connected to a slider 315 that is received in a track 318 supported by the housing 302 to guide and support the carriage as it moves along screw 306.

The carriage 312 is connected to a linkage 314 at a pivot connection 316. The opposite end of the linkage 314 is pivotably connected to a first end 320a of the actuating arm 320 at pin 322 such that the arm 320 can rotate relative to the linkage 314. The arm 320 is pivotably connected to the housing 302 at pin 326 that is located at a point of arm 320 between ends 320a and 320b. The opposite end 320b of the arm 320 extends through a slot formed in the front 302a of housing 302 such that the arm 320 can be extended from the housing upon actuation of the motor 310. The end 320b of arm 320 comprises a roller or other similar bearing surface 330 that contacts an external surface of the door to push on the face of the door and swing the door open about door hinges. The opener of FIG. 8 may be used with the sensor, controller, power source, return spring and limit switches/stepper motor as described above to control the motion of arm 320.

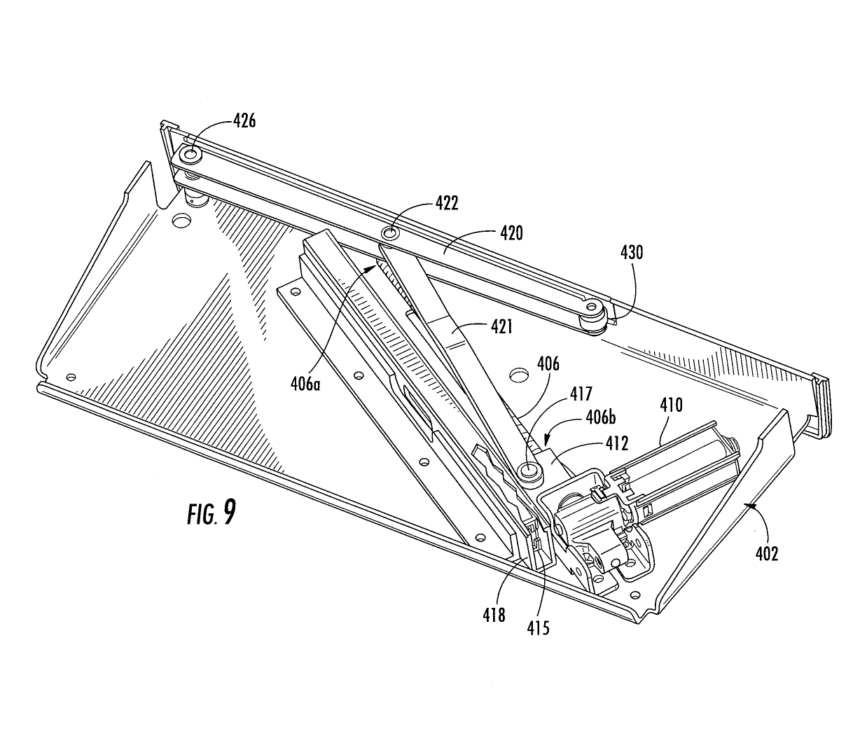

FIG. 9 shows an embodiment of a push-type mechanism. The opener has a housing 402 mounted adjacent a door such that the front of the housing and actuating arm 420 face the door. The door is arranged such that it swings away from the front of housing 402 as previously described. The housing 402 may be mounted to the top of a door jamb, a ceiling or other structure. The housing 402 supports a screw 406 comprising threads. The screw 406 is rotated by a geared motor 410. The screw 406 is angled relative to the retracted or closed position of the arm 420 and the motor 410 is set perpendicular to the screw 406. Motor 410 may also be disposed in-line with screw 406. A carriage 412 is mounted on the screw 406 such that rotation of the screw causes the carriage to move along the length of the screw. The screw 406 is rotated in a first direction to move the carriage toward one end 406a of the screw and is rotated in the opposite direction to move the carriage toward the opposite end 406b of the screw. The carriage 412 is connected to a bearing, roller or slider 415 that is received in a track 418 mounted on the housing 402 to guide and support the carriage 412 as it moves along screw 406. A link 421 is connected to carriage 412 at pivot 417 and to actuator arm 420 at pivot 422. The actuator arm 420 is connected to housing 402 at pivot 426. Actuation of motor 410 rotates screw 406 to cause carriage 412 to move from end 406b toward end 406a. Movement of carriage 412 pushes the linkage 421 which pushes arm 420 from the retracted position to the extended position. The carriage 412 is moved in the same direction as arm 420. The opener of FIG. 9 may be used with the sensor, controller, power source, return spring and limit switches/stepper motor as described above to control the motion of arm 420.

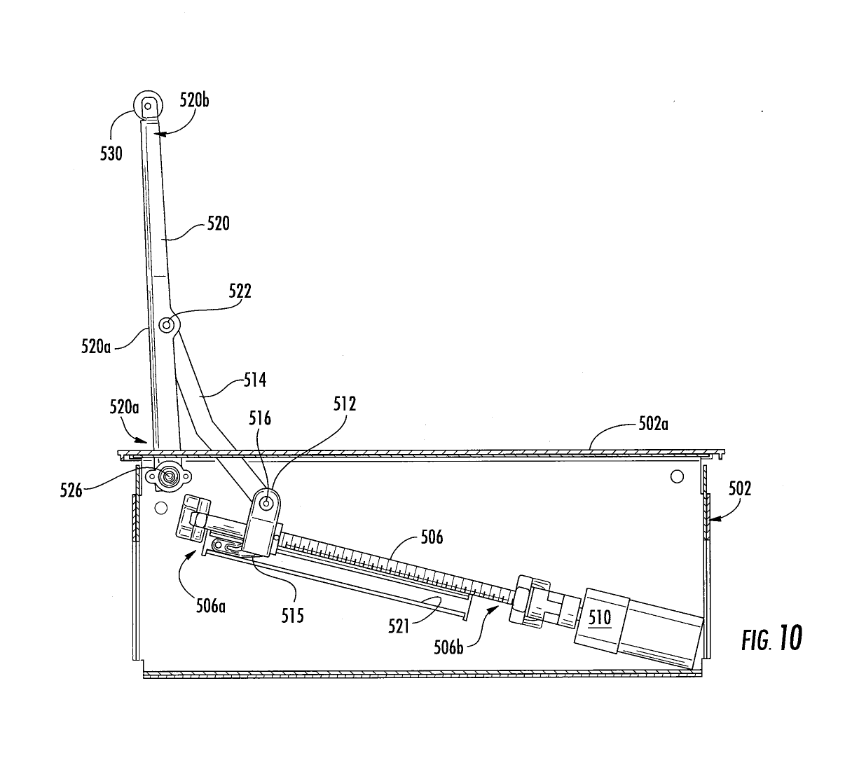

FIG. 10 shows another embodiment of a push-type door opener in the extended or open position. The opener has a housing 502 mounted adjacent a door such that the front 502a of the housing 502 and actuator arm 520 face the door. The door is arranged such that it swings away from the front 502a of housing 502. The housing 502 may be mounted to the top of a door jamb, a ceiling or other structure. The housing 502 supports a screw 506 comprising threads. The screw 506 is arranged at an angle relative to arm 520 when the arm is in the closed or retracted position. The screw 506 is rotated by a geared motor 510. A carriage 512 is mounted on the screw 506 such that rotation of the screw causes the carriage to move along the length of the screw. The screw 506 is rotated in a first direction to move the carriage toward one end 506a of the screw and is rotated in the opposite direction to move the carriage toward the opposite end 506b of the screw. The carriage 512 is connected to a bearing, roller or slider 515 that is received in slot 521 formed in the housing 502 to guide and support the carriage 512 as it moves along screw 506.

The carriage 512 is connected to a linkage 514 at a pivot 516. The opposite end of the linkage 514 is pivotably connected to a point 520c (between ends 520a and 520b) of the actuating arm 520 at pivot 522 such that the arm 520 can rotate relative to the link 514. The arm 520 is pivotably connected to the housing 502 at pin 526 that is located at a first end 520a of arm 520. The arm 520 extends through a slot formed in the front 502a of housing 502 such that the arm 520 can be extended from the housing upon actuation of the motor 510. The end 520b of arm 520 comprises a bearing surface 530 as previously described that contacts an exterior surface of the door to push the door and swing the door open. The device is a push-type in that the carriage moves in the same direction that the arm rotates and “pushes” the linkage to move arm to the open position. The opener of FIG. 10 may be used with the sensor, controller, power source, return spring and limit switches/stepper motor as described above to control the motion of arm 520.

While embodiments of the invention are disclosed herein, various changes and modifications can be made without departing from the spirit and scope of the invention as set forth in the claims. One of ordinary skill in the art will recognize that the invention has other applications in other environments. Many embodiments are possible. The following claims are in no way intended to limit the scope of the invention to the specific embodiments described above.

1. A door opener for opening a door having an external surface comprising:
a screw mounted for rotary motion and a carriage mounted on the screw such that rotation of the screw causes motion of the carriage along the screw;
a motor for rotating the screw;
an actuator arm having a first end and a second end, said actuator arm being operatively connected to the carriage such that movement of the carriage causes the actuator arm to move between a retracted position where the door is closed and an extended position where the door is open, said first end of the actuator arm being in contact with but not connected to the external surface of the door such that the first end of the actuator arm rides over the external surface of the door.

2. The door opener of claim 1 further comprising a bearing on the carriage that resists rotation of the carriage about the axis of screw when the screw is rotated.

3. The door opener of claim 2 wherein the bearing comprises a roller bearing received in a slot.

4. The door opener of claim 1 wherein the carriage is connected to a first end of a linkage at a first pivot and an opposite end of the linkage is pivotably connected to the actuator arm at a second pivot.

5. The door opener of claim 4 wherein the second pivot is positioned at the first end of the actuator arm.

6. The door opener of claim 1 wherein the first end of the actuator arm comprises a bearing surface that contacts the external surface of the door.

7. The door opener of claim 6 wherein the bearing surface comprises a roller that contacts the external surface of the door.

8. The door opener of claim 1 wherein the motor is actuated in response to a signal from a sensor.

9. The door opener of claim 8 further comprising a controller for controlling actuation of the motor, the controller actuating the motor in response to the signal.

10. The door opener of claim 9 wherein the controller activates the motor for a predetermined period of time.

11. The door opener of claim 8 wherein the sensor is a touchless pad.

12. The door opener of claim 1 further comprising a limit switch for stopping the movement of the carriage.

13. A door opener and a door comprising:
a door having an external surface;
a door opener mounted adjacent the door comprising a screw mounted for rotary motion and a carriage mounted on the screw such that rotation of the screw causes motion of the carriage along the screw; a motor for rotating the screw; an actuator arm having a first end and a second end operatively connected to the carriage such that movement of the screw causes the actuator arm to move between a retracted position where the door is closed and an extended position where the door is open, said first end of the actuator arm being in contact with but not connected to the external surface of the door such that the first end of the actuator arm rides over the external surface of the door.

14. The door and door opener of claim 13 wherein the door opener further comprises a housing and a bearing on the carriage received in a slot formed in the housing such that that the bearing resists rotation of the carriage about the axis of screw when the screw is rotated.

15. The door and door opener of claim 13 wherein the carriage is connected to a first end of a linkage at a first pivot and an opposite end of the linkage is pivotably connected to the second end of the actuator arm at a second pivot.

16. The door and door opener of claim 15 wherein the second pivot is disposed between the first end and the second end of the actuator arm.

17. The door and door opener of claim 13 wherein the first end of the actuator arm comprises a bearing surface that contacts the external surface of the door.

18. The door and door opener of claim 13 further comprising a touchless sensor that generates a signal in response to the presence of a user, said motor being activated in response to the signal.

19. The door and door opener of claim 13 wherein the exterior surface comprises a wear plate attached to the door.

20. The door and door opener of claim 13 further comprising a door closer mechanism for moving the door when the actuator arm is moved from the extended position to the retracted position.
